(19) United States
(12) Patent Application Publication
(10) Pub. No.: US 2026/0352393 A1
(43) Pub. Date: Nov. 5, 2026

(54) TERMINAL DEVICE, NETWORK DEVICE AND METHODS FOR COMMUNICATIONS

(71) Applicant: LENOVO (BEIJING) LIMITED, Beijing (CN)

(72) Inventors: Xiaoying Xu, Beijing (CN); Mingzeng Dai, Beijing (CN); Lianhai Wu, Beijing (CN); Ran Yue, Beijing (CN)

(21) Appl. No.: 19/487,958

(22) PCT Filed: May 26, 2023
(86) PCT No.: PCT/CN2023/096535

§ 371 Date: Nov. 25, 2025

(51) Int. Cl. H04L 5/00; H04W 74/0833

(52) U.S. Cl. CPC H04L 5/0044; H04L 5/0005; H04W 74/0833

(57) ABSTRACT

Embodiments of the present disclosure relate to a solution for communications. In one aspect of the solution, a terminal device receives, from a network device, a first configuration for at least one of uplink transmission or downlink reception. The terminal device also receives, from the network device, a second configuration for at least one of an uplink signaling transmission or a downlink signaling reception. In turn, the terminal device performs an uplink signaling transmission or a downlink signaling reception based on at least one of the first configuration or the second configuration.

### FIELD

Embodiments of the present disclosure generally relate to the field of communication, and in particular to terminal device, network device and methods for communications.

### BACKGROUND

Network energy saving (NES) technology is going to be supported in Release 18. According to the NES technology, a cell may be operated in energy saving mode based on a configuration related to NES for the cell. For example, the configuration related to NES may comprise at least one of a cell discontinuous reception (DRX) configuration or a cell discontinuous transmission (DTX) configuration for a terminal device in radio resource control connected (RRC_CONNECTED) mode.

For network energy saving gain, the Third Generation Partnership Project (3GPP) is discussing to prohibit some uplink (UL) and downlink (DL) transmissions from the terminal device in RRC_CONNECTED mode during a non-active duration of a cell DRX and/or DTX pattern. In addition, 3GPP already agreed that a terminal device in RRC_CONNECTED mode supporting NES can perform a Random Access (RA) procedure and receive in System Information Blocks (SIBs) in the non-active duration of the cell DRX and/or DTX pattern to avoid impact terminal devices in RRC_IDLE and RRC_INACTIVE modes. Therefore, it needs to discuss how to balance the network energy saving and transmission and/or reception performance of a terminal device.

### SUMMARY

In general, embodiments of the present disclosure provide a solution for communications.

In a first aspect, there is provided a terminal device. The terminal device comprises a processor and a transceiver coupled to the processor. The processor is configured to: receive, via the transceiver from a network device, a first configuration for at least one of uplink transmission or downlink reception; receive, via the transceiver from the network device, a second configuration for at least one of an uplink signaling transmission or a downlink signaling reception; and perform the uplink signaling transmission or the downlink signaling reception based on at least one of the first configuration or the second configuration.

In a second aspect, there is provided a network device. The network device comprises a processor and a transceiver coupled to the processor. The processor is configured to: transmit, via the transceiver to a terminal device, a first configuration for at least one of uplink transmission or downlink reception; transmit, via the transceiver to the terminal device, a second configuration for at least one of an uplink signaling reception or a downlink signaling transmission; and perform the uplink signaling reception or the downlink signaling transmission based on at least one of the first configuration or the second configuration.

In a third aspect, there is provided a method performed by a terminal device. The method comprises: receiving, at a terminal device from a network device, a first configuration for at least one of uplink transmission or downlink reception; receiving, from the network device, a second configuration for at least one of an uplink signaling transmission or a downlink signaling reception; and performing the uplink signaling transmission or the downlink signaling reception based on at least one of the first configuration or the second configuration.

In a fourth aspect, there is provided a method performed by a network device. The method comprises: transmitting, from a network device to a terminal device, a first configuration for at least one of uplink transmission or downlink reception; transmitting, to the terminal device, a second configuration for at least one of an uplink signaling reception or a downlink signaling transmission; and performing the uplink signaling reception or the downlink signaling transmission based on at least one of the first configuration or the second configuration.

In a fifth aspect, there is provided a computer readable medium. The computer readable medium has instructions stored thereon. The instructions, when executed on at least one processor of a device, causing the device to perform the method of the third aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIG. 1 illustrates a schematic diagram of a communication network in which some embodiments of the present disclosure can be implemented;

FIG. 2 illustrate an example of a cell DRX/DTX pattern for a cell in accordance with some embodiments of the present disclosure;

FIG. 3 illustrates a signaling chart illustrating an example process for communications in accordance with some embodiments of the present disclosure;

FIG. 4 illustrates a signaling chart illustrating an example process for communications in accordance with some embodiments of the present disclosure;

FIGS. 5A and 5B illustrate an example of a first cell DRX pattern and a second cell DRX pattern in accordance with some embodiments of the present disclosure, respectively;

FIG. 6 illustrates a signaling chart illustrating an example process for communications in accordance with other embodiments of the present disclosure;

FIG. 7A illustrates an example of indexes of PRACH configuration in accordance with some embodiments of the present disclosure;

FIG. 7B illustrates an example of PRACH time resources in accordance with some embodiments of the present disclosure;

FIG. 8A illustrates an example of values of PRACH FDM configuration in accordance with some embodiments of the present disclosure;

FIG. 8B illustrates an example of PRACH frequency resources in accordance with some embodiments of the present disclosure;

FIG. 8C illustrates another example of a second plurality of PRACH frequency resources in accordance with some embodiments of the present disclosure;

FIG. 9 illustrates a flowchart of a method implemented at a terminal device in accordance with some embodiments of the present disclosure;

FIG. 10 illustrates a flowchart of a method implemented at a network device in accordance with other embodiments of the present disclosure; and

FIG. 11 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

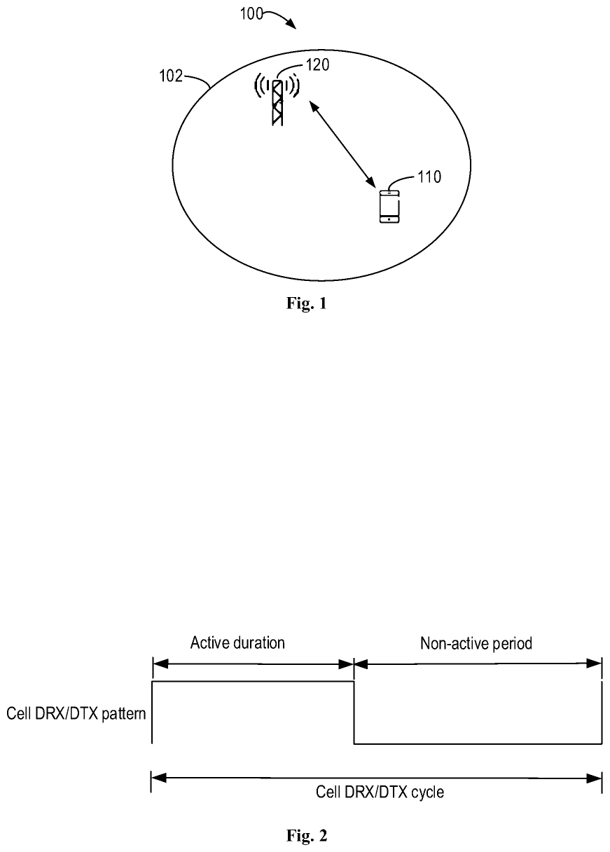

FIG. 1 illustrates a schematic diagram of a communication network in which some embodiments of the present disclosure can be implemented. The communication network 100 includes a terminal device 110 and a network device 120 that can communicate with each other. A serving area of the network device 120 is called as a cell 102.

It is to be understood that the number of network devices and terminal devices is only for the purpose of illustration without suggesting any limitations. The communication network 100 may include any suitable number of network devices and terminal devices adapted for implementing embodiments of the present disclosure. Although not shown, it would be appreciated that one or more terminal devices may be located in the cell 102 and served by the network device 120.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the communication network 100, the terminal device 110 may transmit data and/or signaling to the network device 120 via UL between them. Alternatively, or additionally, the terminal device 110 may receive data and/or signaling from the network device 120 via DL between them.

In some embodiments, in order to support NES, the network device 120 may transmit, to the terminal device 110 in RRC_CONNECTED mode, RRC_INACTIVE mode, or RRC_IDLE mode, at least one of a configuration for a cell DRX pattern or a configuration for a cell DTX pattern for a serving cell (such as the cell 102).

FIG. 2 illustrate an example of a cell DRX/DTX pattern for a cell in accordance with some embodiments of the present disclosure. As shown in FIG. 2, a cell DRX/DTX cycle specifies periodic repetition of an active duration followed by a non-active duration. The cell DRX cycle includes an active duration and a non-active duration. The active duration is a duration in which the network device 120 is active to monitor data and/or signaling within the cell DRX cycle. The active duration may also be referred to as active period or active time. The non-active duration is a duration in which the network device 120 is in a sleep state and does not monitor data and/or signaling. The non-active duration may also be referred to as non-active period or non-active time.

For network energy saving gain, it may prohibit some UL and DL transmissions from the terminal device 110 in RRC_CONNECTED mode during the non-active duration of the cell DRX and/or DTX pattern. For example, it may prohibit UL transmissions which are based on PUSCH (e.g, configured grant) or DL transmissions which are based on PDSCH (e.g. semi-Persistent scheduling).

Currently, 3GPP already agreed that a terminal device in RRC_CONNECTED mode supporting NES can perform an RA procedure and receive in SIBs in the non-active duration of the cell DRX and/or DTX pattern to avoid impact terminal devices in RRC_IDLE and RRC_INACTIVE modes. Therefore, it needs to further discuss how to enhance network energy saving gain for the RA procedure, other UL physical signaling transmission and DL signaling reception procedure in RRC_CONNECTED mode, RRC_INACTIVE mode, or RRC_IDLE mode.

It can be seen from the RA configurations in Table 6.3.3.2-3 and 6.3.3.2-4 in TS 38.211, if physical random access channel (PRACH) resources are configured densely for a terminal device in RRC_CONNECTED mode, a network device needs to wake up to detect uplink transmission over 4-step random access channel (RACH) resource or 2-step RACH resource (i.e., including both RACH and PUSCH resources), which impacts power saving gain regardless of any real RACH transmission. Therefore, it needs to discuss how to balance the network energy saving and transmission and/or reception performance of a terminal device.

In view of the above, embodiments of the present disclosure provide a solution for communications. In the solution, a terminal device receives, from a network device, a first configuration for at least one of uplink transmission and downlink reception. The terminal device also receives, from the network device, a second configuration for at least one of an uplink signaling transmission or a downlink signaling reception. In turn, the terminal device performs an uplink signaling transmission or a downlink signaling reception based on at least one of the first configuration or the second configuration. In this way, balance of the network energy saving and transmission or reception performance of a terminal device may be achieved.

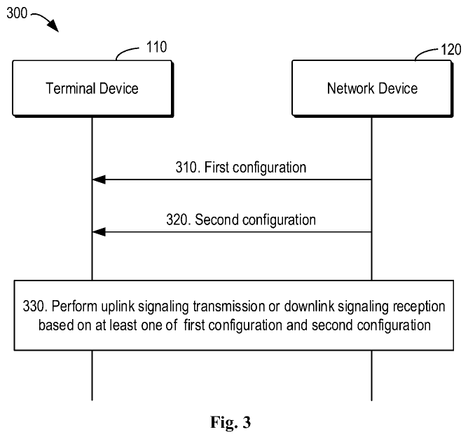

Hereinafter, principle of the present disclosure will be described with reference to FIGS. 3 to 10.

FIG. 3 illustrates a signaling chart illustrating an example process 300 for communications in accordance with some embodiments of the present disclosure. For the purpose of discussion, the process 300 will be described with reference to FIG. 1. The process 300 may involve the terminal device 110 and the network device 120.

As shown in FIG. 3, the terminal device 110 receives 310, from the network device 120, a first configuration for at least one of uplink transmission or downlink reception.

In some embodiments, the uplink transmission may comprise at least one of uplink data transmission or uplink signaling transmission. For example, the uplink data transmission may comprise Physical Uplink Shared Channel (PUSCH) transmission. For example, the uplink signaling transmission may comprise Physical Uplink Control Channel (PUCCH) transmission.

In some embodiments, the downlink transmission may comprise at least one of downlink data transmission or downlink signaling transmission. For example, the downlink data transmission may comprise Physical Downlink Shared Channel (PDSCH) transmission. For example, the downlink signaling transmission may comprise Physical Downlink Control Channel (PDCCH) transmission.

The terminal device 110 also receives 320, from the network device 120, a second configuration for at least one of an uplink signaling transmission or a downlink signaling reception.

In some embodiments, the terminal device 110 may transmit a request to the network device 120. For example, the terminal device 110 may transmit the request via a Layer 1 signaling, layer 2 signaling or layer 3 signaling. The terminal device may receive a response to the request from the network device 120. The response comprises the second configuration.

For example, the network device 120 may configure transmission of the request is allowed. For example, the network device 120 may configure a special resource used for the transmission of the request. The special resource may include at least one of the following:
RACH preamble and/or RACH occasions. In this case, the terminal device 110 transmits RACH preamble on a RACH occasion.
Demodulation Reference Signal (DMRS) resource. In this case, the terminal device 110 transmits DMRS on a PUSCH occasion.
Sounding Reference Signal (SRS) resource. In this case, the terminal device 110 transmits SRS on a SRS occasion.
Wake up signaling (WUS) resource. In this case, the terminal device 110 transmits WUS on a WUS occasion.
Configured PUSCH resource/occasion. In this case, the terminal device 110 transmits MAC CE, RRC signaling on a configured PUSCH resource/occasion.

For example, the above resources may be associated with the second configuration. For example, the association may be configured by the network device 120 or predefined

In turn, the terminal device 110 performs 330 an uplink signaling transmission to the network device 120 or a downlink signaling reception from the network device 120 based on at least one of the first configuration or the second configuration.

In some embodiments, the terminal device 110 receives the first configuration and the second configuration from the network device 120, and the terminal device 110 switches the configuration between the first configuration and the second configuration according to the status of the cell DRX mode. For example, the second configuration is used in the cell DRX activation mode and associated with the cell DRX activation mode, and the first configuration is used in cell DRX deactivation mode and associated with the cell DRX deactivation mode. The association between the configuration and cell DRX mode may be configured by the network device 120. The terminal device 110 switches from the first configuration to the second configuration if the terminal device 110 activates the cell DRX mode of the serving cell. The terminal device 110 switches from the second configuration to the first configuration if the terminal device 110 deactivates the cell DRX mode of the serving cell.

In some embodiments, the terminal device 110 receives the first configuration and the second configuration from the network device 120, and the terminal device 110 switches the configuration between the first configuration and the second configuration according to the status of the cell DTX mode. For example, the second configuration is used in the cell DTX activation mode and associated with the cell DTX activation mode, and the first configuration is used in cell DTX deactivation mode and associated with the cell DTX deactivation mode. The association between the configuration and cell DTX mode may be configured by the network device 120. The terminal device 110 switches from the first configuration to the second configuration if the terminal device 110 activates the cell DTX mode of the serving cell. The terminal device 110 switches from the second configuration to the first configuration if the terminal device 110 deactivates the cell DTX mode of the serving cell.

With the process 300, balance of the network energy saving and transmission or reception performance of a terminal device may be achieved.

In some embodiments, the uplink signaling transmission may comprise a transmission of at least one of the following: RA request, Channel Status Information (CSI), Hybrid Automatic Repeat request (HARQ) feedback, Scheduling Request (SR), Sounding Reference Signal (SSS), or Positioning Reference Signal (PRS).

In some embodiments, the terminal device 110 may transmit at least one of CSI, HARQ feedback or SR on Physical Uplink Control Channel (PUCCH). Since SR is triggered by buffer status report (BSR), the transmission requirement is related to the UL traffic arrival pattern. HARQ-feedback transmission requirement is related to DL traffic reception at the terminal device 110. CSI transmission is used for the DL channel quality estimation based on CS-RS resource. SRS transmission is used for UL channel quality estimation. PRS transmission is related to positioning. These physical signalings have different transmission pattern comparison to the uplink traffic. Thus, it is reasonable for the terminal device 110 to performs such uplink signaling transmission based on the second configuration.

In some embodiments, the uplink signaling reception comprises a reception of at least one of the following: Channel Status Information Reference Signal (CSI-RS) or PRS.

Hereinafter, some embodiments of the present disclosure will be described by taking RA request transmission as an example of uplink signaling transmission.

In some embodiments, the first configuration may indicate a first plurality of resources for one or more uplink signaling transmissions and/or one or more downlink signaling receptions. The second configuration may indicate a second plurality of resources for one or more uplink signaling transmissions and/or one or more downlink signaling receptions. In some embodiments, each of the first plurality of resources and the second plurality of resources may comprise at least one of a time resource or a frequency resource.

In some embodiments, the first plurality of resources may be associated with a first periodicity, and the second plurality of resources may be associated with a second periodicity. The first periodicity is different from the second periodicity. For example, the first periodicity is less than the second periodicity.

In some embodiments, the first plurality of resources may be associated with a first number of the first plurality of resources in a first periodicity, and the second plurality of resources may be associated with a second number of the second plurality of resources in a second periodicity. The first number is different from the second number. For example, the first number is greater than the second number. The first periodicity is different from or the same as the second periodicity. One extra example, the second number of the second plurality of resources is zero. This means the cell switches off the transmission or reception over the resource.

In some embodiments where the uplink signaling transmission comprises an RA request transmission, the first plurality of resources may comprise a first number of PRACH resources in a first periodicity and the second plurality of resources may comprise a second number of PRACH resources in a second periodicity. Each of the PRACH resources may comprises a PRACH time resource and a PRACH frequency resource. For example, the PRACH resources may comprise PRACH occasions. In such embodiments, the terminal device 110 may determine the second number of PRACH occasions (also referred to as RO) based on the second configuration. If the second number is less than the first number, the number of PRACH occasions on which the network device 120 needs to wake up for receiving preambles are reduced. Thus, more energy saving gain can be expected for the network device 120.

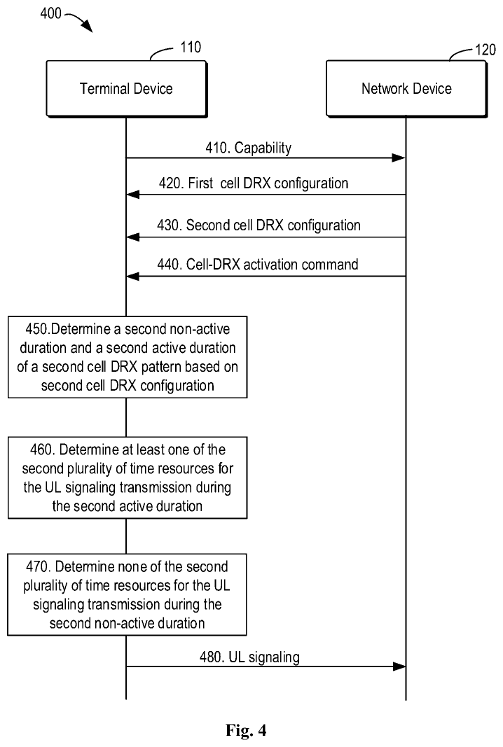

FIG. 4 illustrates a signaling chart illustrating an example process 400 for communications in accordance with some embodiments of the present disclosure. The process 400 may be considered as an example implementation of the process 300. For the purpose of discussion, the process 400 will be described with reference to FIG. 1. The process 400 may involve the terminal device 110 and the network device 120.

Generally, in the process 400, the first configuration comprises a first cell DRX configuration for a serving cell of the terminal device 110, and the second configuration comprises a second cell DRX configuration for the serving cell.

As shown in FIG. 4, the terminal device 110 transmits 410, to the network device 120, capability information indicating support of the second cell DRX configuration and/or second cell DTX configuration.

The network device 120 transmits 420 a first cell DRX configuration for a serving cell of the terminal device 110. In addition, the network device 120 transmits 430 a second cell DRX configuration for the serving cell of the terminal device 110. In some embodiments, the first cell DRX configuration may be (legacy) cell DRX configuration specified in 3GPP Release 18. In some embodiments, the second cell DRX configuration may be enhanced cell DRX configuration specified after 3GPP Release 18.

The first cell DRX configuration may be associated with a first cell DRX pattern for the serving cell of the terminal device 110. The second cell DRX configuration may be associated with a second cell DRX pattern for the serving cell of the terminal device 110.

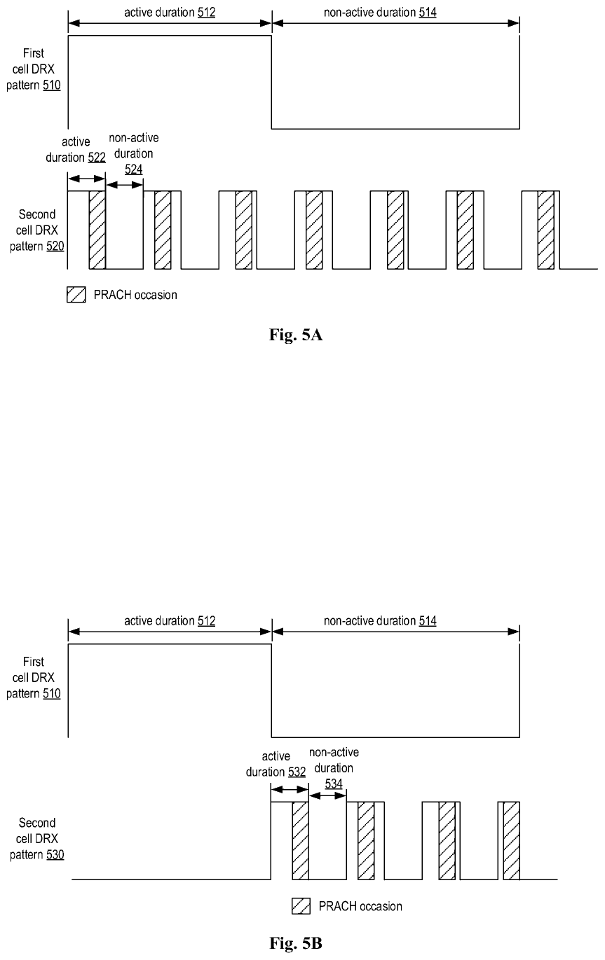

FIG. 5A illustrates an example of a first cell DRX pattern 510 and a second cell DRX pattern 520 in accordance with some embodiments of the present disclosure. The first cell DRX pattern 510 is associated with the first cell DRX configuration. The second cell DRX pattern 520 is associated with the second cell DRX configuration.

As shown in FIG. 5A, the first cell DRX pattern 510 comprises a first active duration 512 and a first non-active duration 514. The second cell DRX pattern 520 comprises a second active duration 522 and a second non-active duration 524.

Each of the first cell DRX configuration and the second cell DRX configuration may comprises at least one of the following:
periodicity which defines a cell DRX cycle length.
Offset and/or Slot offset which defines the subframe and/or slot where the cell DRX cycle starts.
onDurationTimer which defines an active duration at the beginning of the cell DRX cycle.

The terminal device 110 determines the time instance to start the onDurationTimer based on at least one of the following: the periodicity, system frame number (SFN), subframe number, offset, slot offset. For example, according to the cell DRX configuration, the terminal device 110 determines the subframe to start the onDurationTimer if (SFN number*10+sub frame)mod periodicity=offset. The terminal device 110 determines the slot to start the on DurationTimer according to the slot offset.

In some embodiments, the second cell DRX configuration may be configured independently from the first cell DRX configuration. That means the Offset of the second cell DRX configuration may be relative to the start boundary of the a system frame when receiving the second cell DRX configuration or the closest SFN=0 or SFN=512 which is the preceding the reception of the second cell DRX configuration.

Alternatively, in some embodiments, a second cell DRX pattern may be configured for a non-active duration of a first cell DRX pattern or a second cell DRX pattern may be only used during a non-active duration of a first cell DRX pattern. This will be described with reference to FIG. 5B.

FIG. 5B illustrates an example of the first cell DRX pattern 510 and a second cell DRX pattern 530 in accordance with some embodiments of the present disclosure. The first cell DRX pattern 510 is associated with the first cell DRX configuration. The second cell DRX pattern 530 is associated with the second cell DRX configuration.

As shown in FIG. 5B, the first cell DRX pattern 510 comprises the first active duration 512 and the first non-active duration 514. The second cell DRX pattern 530 comprises a second active duration 532 and a second non-active duration 534. The second cell DRX pattern 530 is configured for the first non-active duration 514 of the first cell DRX pattern 510.

That means the Offset of the second cell DRX configuration may be relative to the boundary (e.g., a subframe or a slot or a symbol) of the first cell DRX pattern. For example, the Offset of the second cell DRX configuration may be relative to the end of the boundary of the first active duration 512 of the first cell DRX pattern 510 or the beginning of the first non-active duration 514 of the first cell DRX pattern 510.

With continued reference to FIG. 4, the network device 120 transmits 440 a cell DRX activation or deactivation command for a serving cell via dynamical or semi-static signaling to the terminal device 110. The command indicates whether to activate at least one of the first and second cell DRX configurations for the terminal device 110.

In some embodiments, the command may include in downlink control information (DCI), Radio Resource Control (RRC) or Medium Access Control Control Element (MAC CE).

In embodiments where the MAC CE is used, the MAC CE may comprise at least one of the following:
one or more fields which are used to indicate the activation/deactivation status, the field set to value 1 presents activation status, the field set to value 0 presents deactivation status;
one or more fields which are used to indicate which cell(s) is to be activated/deactivated; or
one or more fields which are used to indicate which cell DRX configuration is to be activated/deactivated.

For example, a field includes an index of a cell DRX configuration.

For example, a field includes a bitmap, wherein each bit position is corresponding to one cell DRX configuration, the bit value is used to indicate the activation/deactivation status. For example, the Bit i in this field indicates the activation/deactivation status of a cell DRX configuration i, where i is the ascending/descending order of cell DRX configurations for a serving cell.

For example, a specified logical channel identifier (LCID) in an associated MAC sub-header is used to identify the MAC CE.

In embodiments where the DCI on PDCCH is used, the PDCCH may be scrambled with a specific group or common Radio Network Temporary Identifier (RNTI). The RNTI can be configured by the network device 120 or predefined. The RNTI is only used to order the terminal device 110 to activate or deactivate the cell DRX configuration.

For example, a first RNTI is used to order the terminal device 110 to activate or deactivate the first cell DRX configuration, and a second RNTI is used to order the terminal device 110 to activate or deactivate the second cell DRX configuration.

For another example, one RNTI is commonly used to order the terminal device 110 to activate or deactivate the first cell DRX configuration and the second cell DRX configuration.

Accordingly, the terminal device 110 receives the cell DRX activation or deactivation command.

In some embodiments, the terminal device 110 applies the command immediately when receiving the command. Alternatively, the terminal device 110 applies the command with some fixed delay or configured delay by the network device 120 after receiving the command or the PDCCH scheduling the command.

In some embodiments, if the activation command indicates the second cell DRX configuration is to be activated, the terminal device 110 activates the second cell DRX configuration for the serving cell.

In some embodiments, the terminal device 110 may not consider the first cell DRX pattern for the cell DRX active duration for uplink signaling transmission. In such embodiments, the terminal device 110 determines 450 a second non-active duration and a second active duration of a second cell DRX pattern based on the second cell DRX configuration.

Then, the terminal device 110 determines (or selects) 460 at least one of the second plurality of time resources for the UL signaling transmission during the second active duration. The terminal device 110 determines 470 none of the second plurality of time resources for the uplink signaling transmission during the second non-active duration. In other words, the terminal device 110 may not select any of the second plurality of time resources for the uplink signaling transmission during the second non-active duration. The terminal device 110 may not perform the uplink signaling transmission during the second non-active duration.

Alternatively, in some embodiments, the terminal device 110 determines a first non-active duration of a first cell DRX pattern based on the first cell DRX configuration. The terminal device 110 determines a second active duration of a second cell DRX pattern based on the second cell DRX configuration during the first non-active duration of the first cell DRX pattern. Then, the terminal device 110 determines at least one of the second plurality of time resources for the UL signaling transmission during the second active duration of the second cell DRX pattern.

Then, the terminal device 110 performs 480 the uplink signaling transmission on the at least one of the second plurality of resources during the second active duration.

In some embodiments, if the activation command indicates the second cell DRX configuration is to be deactivated, the terminal device 110 deactivates the second cell DRX configuration for the serving cell. For example, the terminal device 110 does determine the active duration for uplink signaling transmission is not restricted by the second cell DRX pattern for the serving cell.

Alternatively, in some embodiments, the first configuration comprises a first cell DTX configuration for a serving cell of the terminal device 110, and the second configuration comprises a second cell DTX configuration for the serving cell. In some embodiments, the first cell DTX configuration may be (legacy) cell DTX configuration specified in 3GPP Release 18. In some embodiments, the second cell DTX configuration may be enhanced cell DTX configuration specified after 3GPP Release 18.

In some embodiments, the terminal device 110 determines a first non-active duration of a first cell DTX pattern based on the first cell DTX configuration. The terminal device 110 also determines a second active duration of a second cell DTX pattern based on the second cell DTX configuration only during the first non-active duration of the first cell DTX pattern. In turn, the terminal device 110 performs the downlink signaling reception on at least one of the second plurality of resources during the second active duration.

Each of the first cell DTX configuration and the second cell DTX configuration may comprises at least one of the following:
periodicity which defines a cell DTX cycle length.
Offset and/or Slot offset which defines the subframe and/or slot where the cell DTX cycle starts.
onDurationTimer which defines an active duration at the beginning of the cell DTX cycle.

The terminal device 110 determines the time instance to start the onDurationTimer based on at least one of the following: the periodicity, system frame number (SFN), subframe number, offset, slot offset. For example, according to the cell DTX configuration, the terminal device 110 determines the subframe to start the onDurationTimer if (SFN number*10+sub frame)mod periodicity=offset. The terminal device 110 determines the slot to start the onDurationTimer according to the slot offset.

In some embodiments, the second cell DTX configuration may be configured independently from the first cell DTX configuration. That means the Offset of the second cell DTX configuration may be relative to the start boundary of a system frame when receiving the second cell DTX configuration or the closest SFN=0 or SFN=512 which is the preceding the reception of the second cell DTX configuration.

Alternatively, in some embodiments, a second cell DTX pattern may be configured for a non-active duration of a first cell DTX pattern or a second cell DTX pattern may be only used during a non-active duration of a first cell DTX pattern.

For example, the Offset of the second cell DTX configuration may be relative to the boundary (e.g., a subframe or a slot or a symbol) of the first cell DTX pattern. For example, the Offset of the second cell DTX configuration may be relative to the end of the boundary of the first active duration 512 of the first cell DTX pattern 510 or the beginning of the first non-active duration 514 of the first cell DTX pattern 510.

With continued reference to FIG. 4, the network device 120 transmits 440 a cell DTX activation or deactivation command for a serving cell via dynamical or semi-static signaling to the terminal device 110. The command indicates whether to activate at least one of the first and second cell DTX configurations for the terminal device 110.

In some embodiments, the command may include in downlink control information (DCI), Radio Resource Control (RRC) or Medium Access Control Control Element (MAC CE).

In embodiments where the MAC CE is used, the MAC CE may comprise at least one of the following:
one or more fields which are used to indicate the activation/deactivation status, the field set to value 1 presents activation status, the field set to value 0 presents deactivation status;
one or more fields which are used to indicate which cell(s) is to be activated/deactivated.
one or more fields which are used to indicate which cell DTX configuration is to be activated/deactivated.

For example, a field includes an index of a cell DTX configuration.

For example, a field includes a bitmap, wherein each bit position is corresponding to one cell DTX configuration, the bit value is used to indicate the activation/deactivation status. For example, the Bit i in this field indicates the activation/deactivation status of a cell DTX configuration i, where i is the ascending/descending order of cell DTX configurations for a serving cell.

For example, a specified logical channel identifier (LCID) in an associated MAC sub-header is used to identify the MAC CE.

In embodiments where the DCI on PDCCH is used, the PDCCH may be scrambled with a specific group or common Radio Network Temporary Identifier (RNTI). The RNTI can be configured by the network device 120 or predefined. The RNTI is only used to order the terminal device 110 to activate or deactivate the cell DTX configuration.

For example, a first RNTI is used to order the terminal device 110 to activate or deactivate the first cell DTX configuration, and a second RNTI is used to order the terminal device 110 to activate or deactivate the second cell DTX configuration.

For another example, one RNTI is commonly used to order the terminal device 110 to activate or deactivate the first cell DTX configuration and the second cell DTX configuration.

Accordingly, the terminal device 110 receives the cell DTX activation or deactivation command.

In some embodiments, the terminal device 110 applies the command immediately when receiving the command. Alternatively, the terminal device 110 applies the command with some fixed delay or configured delay by the network device 120 after receiving the command or the PDCCH scheduling the command.

Alternatively, in some embodiments, the terminal device 110 determines a second non-active duration of the second cell DTX pattern based on the second cell DTX configuration. The terminal device 110 determines none of the second plurality of time resources for the signaling reception during the second non-active duration. In other words, the terminal device 110 does not use any of the second plurality of time resources for the downlink signaling reception during the second non-active duration. The terminal device 110 does not perform the downlink signaling reception during the second non-active duration of the second cell DTX pattern.

In embodiments where the first plurality of resources comprise a first number of uplink signaling transmission resources and the second plurality of resources comprise a second number of uplink signaling transmission resources, the first number of uplink signaling transmission resources may be updated to the second number of uplink signaling transmission resources.

In embodiments where the first plurality of resources comprise a first number of downlink signaling transmission resources and the second plurality of resources comprise a second number of downlink signaling transmission resources, the first number of downlink signaling transmission resources may be updated to the second number of downlink signaling transmission resources.

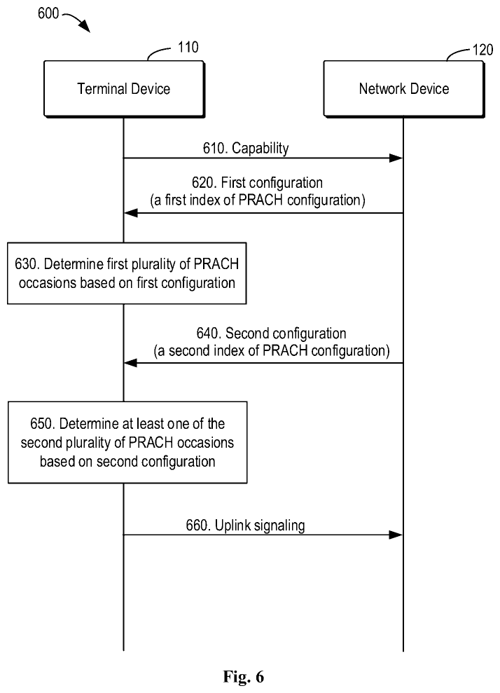

In embodiments where the first plurality of resources comprise a first number of PRACH resources and the second plurality of resources comprise a second number of PRACH resources, the first number of PRACH resources may be updated to the second number of PRACH resources. This will be described with reference to FIGS. 6, 7A, 7B, 8A, 8B and 8C.

FIG. 6 illustrates a signaling chart illustrating an example process 600 for communications in accordance with some embodiments of the present disclosure. The process 600 may be considered as another example implementation of the process 300. For the purpose of discussion, the process 600 will be described with reference to FIG. 1. The process 600 may involve the terminal device 110 and the network device 120.

As shown in FIG. 6, the terminal device 110 transmits 610, to the network device 120, capability information indicating support of the second configuration.

The network device 120 transmits 620 the first configuration to the terminal device 110.

In some embodiments, the first configuration comprises first information which indicates at least one of the following:
a first index of UL/DL resource or resource configuration,
a first periodicity of UL/DL resource configuration, or
a first number of occasions of UL/DL resource configuration.

In some embodiments, the UL resource configuration may comprise one of the following: PRACH configuration, CSI resource configuration, HARQ feedback resource configuration, SR resource configuration, SRS resource configuration, or PRS resource configuration.

In some embodiments, the first configuration comprises first information which indicates at least one of the following:
a first index of PRACH configuration,
a first PRACH periodicity of PRACH configuration,
a first number of PRACH occasions of PRACH configuration, or
a first value of PRACH Frequency-division multiplexing (FDM) configuration.

In some embodiments, the first number may be one of the following: the number of subframes or subframe numbers within a system frame comprising PRACH occasions, the number of PRACH slots or slot numbers within a subframe, or the number of PRACH occasions within a PRACH slot.

Alternatively, in some embodiments, the first configuration comprises first information which indicates at least one of the following:
a first index of CSI resource configuration, or
a first periodicity of CSI resource configuration.

Alternatively, in some embodiments, the first configuration comprises first information which indicates at least one of the following:
a first index of HARQ feedback resource configuration, or
a first periodicity of HARQ feedback resource configuration.

Alternatively, in some embodiments, the first configuration comprises first information which indicates at least one of the following:
a first index of Schedule Request resource configuration,
a first periodicity of SR resource configuration, or
a first number of resources of SR resource configuration.

Alternatively, in some embodiments, the first configuration comprises first information which indicates at least one of the following:
a first index of Sounding Reference Signal resource Set or SRS resource,
a first periodicity of SRS resource Set or SRS resource, or
a first number of resources of SRS resource configuration.

Alternatively, in some embodiments, the first configuration comprises first information which indicates at least one of the following:
a first index of UL Position Reference Signal (e.g., SRS-Position) resource,
a first periodicity of UL PRS resource, or
a first number of resources of UL PRS resource configuration.

In some embodiments, the DL resource configuration may comprise one of the following: CSI-RS resource configuration, or PRS resource configuration. In some embodiments, the first configuration comprises first information which indicates at least one parameter for the CSI-RS resource configuration or PRS resource configuration.

Alternatively, in some embodiments, the first configuration comprises first information which indicates at least one of the following:
a first index of DL Position Reference Signal resource,
a first periodicity of DL PRS resource configuration, or
a first number of resources of DL PRS resource configuration.

Alternatively, in some embodiments, the first configuration comprises first information which indicates at least one of the following:
a first index of CSI-RS (Channel State Information Reference Signal) resource,
a first periodicity of CSI-RS resource configuration, or
a first number of resources of CSI-RS resource configuration.

Accordingly, the terminal device 110 receives the first configuration. In turn, the terminal device 110 determines 630 a first plurality of PRACH occasions based on the first configuration.

The network device 120 transmits 640 the second configuration to the terminal device 110.

In some embodiments, the second configuration comprises second information which indicates at least one of the following:
a second index of UL/DL resource configuration,
a second periodicity of UL/DL resource configuration, or
a second number of occasions of UL/DL resource configuration.

In some embodiments, the UL resource configuration may comprise one of the following: PRACH configuration, CSI resource configuration, HARQ feedback resource configuration, SR resource configuration, SRS resource configuration, or PRS resource configuration.

For example, in embodiments where the UL resource configuration comprises PRACH configuration, the second configuration comprises second information which indicates one of the following:
a second index of PRACH configuration,
a second PRACH periodicity of PRACH configuration,
a second number of PRACH occasions of PRACH configuration, or
a second value of PRACH FDM configuration.

Similarly, in embodiments where the UL resource configuration comprises CSI resource configuration, HARQ feedback resource configuration, SR resource configuration, SRS resource configuration, or PRS resource configuration, the second configuration comprises second information which indicates at least one parameter for the CSI resource configuration, HARQ feedback resource configuration, SR resource configuration, SRS resource configuration, or PRS resource configuration.

In some embodiments, the DL resource configuration may comprise one of the following: CSI-RS resource configuration, or PRS resource configuration. In some embodiments, the second configuration comprises first information which indicates at least one parameter for the CSI-RS resource configuration or PRS resource configuration.

Hereinafter, each of the first configuration and the second configuration will be described by taking PRACH configuration as an example. The scope of the present disclosure is not limited to the PRACH configuration.

In some embodiments, the network device 120 may transmit a command to the terminal device 110. The command comprises the second configuration. For example, if the network device 120 determines to switch to cell DRX mode for RA request transmission, the network device 120 may transmit the command to the terminal device 110.

In some embodiments, the command may be a Layer1 signaling by PDCCH, Layer 2 signaling by MAC, System Information Block or Layer 3 signaling by RRC message.

In some embodiments, the command may include at least one of the following:
one or more fields which are used to indicate which cell(s) to apply the command; if the field is not present, the terminal device 110 considers this cell is the serving cell from which the command is received, or the cells are the serving cells of the MAC entity by which the command is received; or
one or more fields which are used to indicate the second information.

If the terminal device 110 receives the command comprising the second configuration, the terminal device 110 applies the command.

For example, the terminal device 110 applies the command at the next Nth RACH period (N=1, 2, 3 . . . ). N may be predefined in specification or configured by the network device 120. Alternatively, the terminal device 110 applies the command at the current RACH period.

For example, the terminal device 110 applies the command with a fixed delay after receiving the command or the PDCCH scheduling the command. The delay value may be predefined or configured by the network device 120.

For another example, the terminal device 110 applies the command after transmitting acknowledge of the command to the network device 120.

Then, the terminal device 110 determines 650 at least one of the second plurality of PRACH occasions based on the second configuration.

In turn, the terminal device 110 performs 660 the uplink signaling transmission on at least one of the second plurality of PRACH occasions.

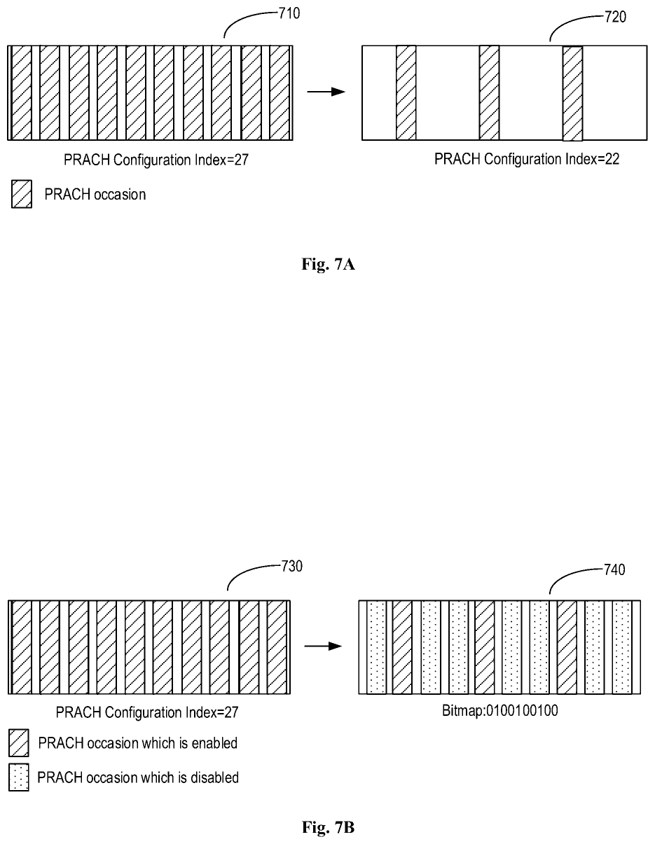

FIG. 7A illustrates an example of a first index of PRACH configuration (also referred to as a first PRACH configuration index) 710 and a second index of PRACH configuration (also referred to as a second PRACH configuration index) 720 in accordance with some embodiments of the present disclosure. As shown in FIG. 7A, the first PRACH configuration index is equal to 27 and the second PRACH configuration index is equal to 22.

The first PRACH configuration index of 27 is associated with a first number of PRACH occasions of PRACH configuration. The second PRACH configuration index of 22 is associated with a second number of PRACH occasions of PRACH configuration. The second number is less than the first number. In this way, if the terminal device 110 applies the second PRACH configuration index, the number of PRACH occasions for monitoring preambles is reduced. Thus, more energy saving gain can be expected for the network device 120.

Alternatively, the first index of PRACH configuration may be a first msgA-PRACH-ConfigurationIndex, and the second index of PRACH configuration may be a second msgA-PRACH-ConfigurationIndex.

In some embodiments, a code point may be predefined. The code point maps a prach-ConfigurationIndex or msgA-PRACH-ConfigurationIndex in a RACH access configuration table in TS 38.211 instead of the PRACH configuration index. Table 1 shows an example of mapping between Index and prach-ConfigurationIndex.

TABLE 1

| Index | prach-ConfigurationIndex |
|---|---|
| 0 | 24 |
| 1 | 25 |

In some embodiments, the mapping between Index and prach-ConfigurationIndex can be configured by RRC message, or System Information Block or predefined.

Alternatively, in some embodiments, the second plurality of PRACH resources may be a subset of the first plurality of PRACH resources. Thus, with the second configuration, the number of PRACH time resources for monitoring preambles is reduced. Thus, more energy saving gain can be expected for the network device 120.

In some embodiments, a bitmap may be used to indicate a subset of the first plurality of PRACH time resources used for RA request transmission.

FIG. 7B illustrates an example of a first plurality of PRACH time resources 730 and a second plurality of PRACH time resources 740 in accordance with some embodiments of the present disclosure. As shown in FIG. 7B, the first PRACH configuration index of 27 is associated with the first plurality of PRACH time resources 730, and a bitmap 740 is used to indicate a subset of the first plurality of PRACH time resources 730 used for RA request transmission.

In some embodiments, each bit position in a bitmap corresponds to a PRACH time resource in a period. For example, each bit position in a bitmap corresponds to a PRACH subframe, a PRACH slot or a PRACH occasion. For example, an Ri field indicates the enable/disable status of the PRACH time resource i, where i is the ascending/descending order of PRACH resources of a serving cell in a RACH period. For example, the first/leftmost bit in a bitmap corresponds to the first PRACH resource in the period.

In some embodiments, the Ri field is set to 1 to indicate that the PRACH resource i shall be enabled. The Ri field is set to 0 to indicate that the PRACH resource i shall be disabled.

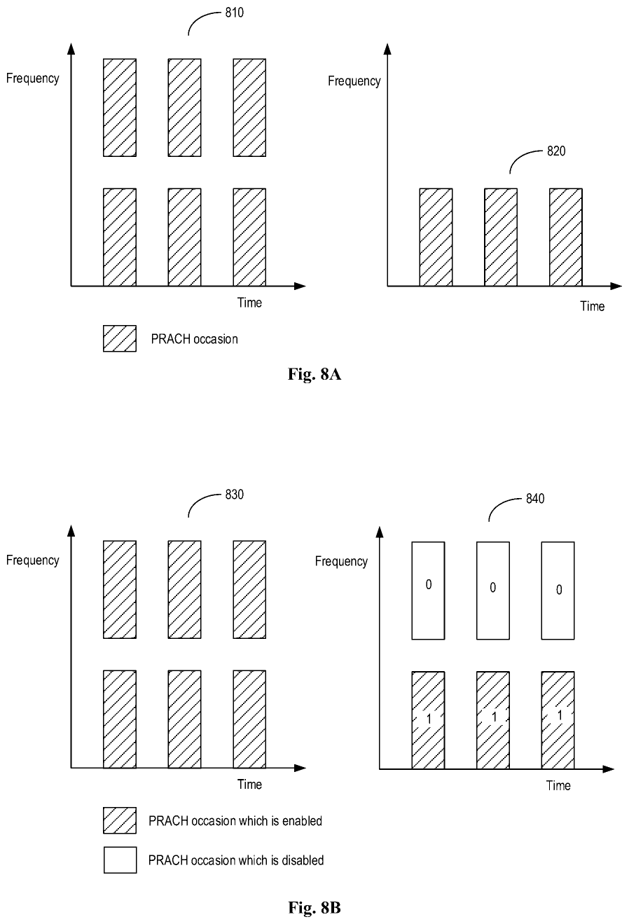

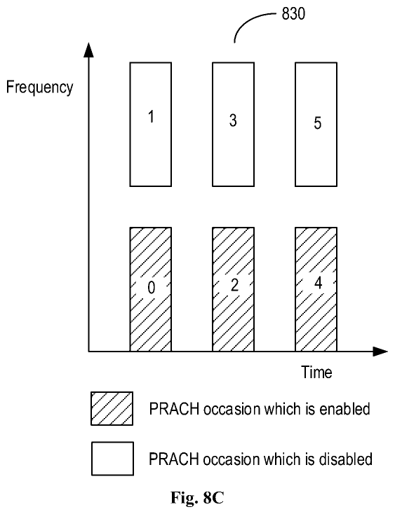

FIG. 8A illustrates an example of values of PRACH FDM configuration in accordance with some embodiments of the present disclosure. As shown in FIG. 8A, a first configuration 810 comprises first information which indicates a first value of PRACH FDM configuration, and a second configuration 820 comprises second information which indicates a second value of PRACH FDM configuration.

In some embodiments, the network device 120 may transmit the second configuration 820 by a Layer 1, Layer 2 or Layer 3 message.

In some embodiments, the first value of PRACH FDM configuration may comprise a first msg1-FrequencyStart or a first msg1-FDM. The first msg1-FDM indicates a first number of PRACH occasions frequency-division multiplexed in one time instance (such as a slot or a subframe). The first msg1-FrequencyStart indicates a first start position of the PRACH occasions in frequency domain, i.e., Offset of lowest PRACH occasion in frequency domain with respective to physical resource block (PRB) 0.

In some embodiments, the second value of PRACH FDM configuration may comprise a second msg1-FrequencyStart or a second msg1-FDM. The second msg1-FDM indicates a second number of PRACH occasions frequency-division multiplexed in one time instance (such as a slot or a subframe). The second msg1-FrequencyStart indicates a second start position of the PRACH occasions in frequency domain, i.e., Offset of lowest PRACH occasion in frequency domain with respective to PRB 0.

For example, as shown in FIG. 8A, the first msg1-FDM is equal to 2 and the second msg1-FDM is equal to 1. In this way, with the second msg1-FDM, the number of PRACH frequency resources for monitoring preambles is reduced. Thus, more energy saving gain can be expected for the network device 120.

In some embodiments, a bitmap may be used to indicate a subset of a first plurality of PRACH frequency resources used for RA request transmission.

FIG. 8B illustrates an example of a first plurality of PRACH frequency resources 830 and a second plurality of PRACH frequency resources 840 in accordance with some embodiments of the present disclosure. As shown in FIG. 8B, the second plurality of PRACH frequency resources 840 is a subset of the first plurality of PRACH frequency resources 830. A bitmap is used to indicate a subset of the first plurality of PRACH frequency resources 840 used for RA request transmission.

In some embodiments, N bits may be used, where N is equal to the number of PRACH occasions in one time instance, and each bit corresponds to a PRACH occasion. For example, in the example of FIG. 8B, N is equal to 2.

In some embodiments, an Ri field indicates the enable/disable status of the PRACH frequency resource i, where i is the ascending/descending order of PRACH frequency resources of a serving cell in one time instance. For example, the first/leftmost bit in a bitmap corresponds to the first PRACH frequency resource in one time instance.

For example, the Ri field is set to 1 to indicate that the PRACH frequency resource i shall be enabled. The Ri field is set to 0 to indicate that the PRACH frequency resource i shall be disabled.

FIG. 8C illustrates another example of a second plurality of PRACH time and frequency resources in accordance with some embodiments of the present disclosure. As shown in FIG. 8C, a second plurality of PRACH time and frequency resources 850 is a subset of the first plurality of PRACH time and frequency resources 830 in FIG. 8B. A bitmap is used to indicate a subset of the first plurality of PRACH time and frequency resources 830 used for RA request transmission. N bits may be used, where N is equal to the number of PRACH occasions in a RACH period, and each bit corresponds to a PRACH occasion. For example, in the example of FIG. 8C, N is equal to 6.

For example, an Ri field indicates the enable/disable status of a PRACH occasion i, where i is the ascending/descending order of the time and PRACH frequency resources of a serving cell in a RACH period. For example, the first/leftmost bit corresponds to the first PRACH time and frequency resource in the RACH period. In the example of FIG. 8C, the bitmap may be “101010” which indicates that PRACH occasions #0, #2 and #4 are enabled and PRACH occasions #1, #3 and #5 are disabled.

In some embodiments, the terminal device 110 receives the first configuration with resource for the UL signaling transmission and the second configuration with resource for the UL signaling transmissions from the network device 120.

For example, the second configuration is used in a cell DRX activation mode and associated with the cell DRX activation mode, and the first configuration is used in a cell DRX deactivation mode and associated with the cell DRX deactivation mode.

For example, the association between the configuration and cell DRX mode may be configured by the network device 120.

In some embodiments, the terminal device 110 switches from the first configuration to the second configuration for UL signaling transmission if the terminal device 110 activates the cell DRX mode of the serving cell for the uplink signaling transmissions.

In some embodiments, the terminal device 110 switches from the second configuration to the first configuration for the UL signaling transmission if the terminal device 110 deactivates the cell DRX mode of the serving cell for the uplink signaling transmissions.

In some embodiments, the terminal device 110 receives the first configuration with resource at least for the DL signaling transmission, and the second configuration with resource at least for the DL signaling transmission from the network device 120.

For example, the second configuration is used in a cell DTX activation mode and associated with the cell DTX activation mode, and the first configuration is used in a cell DTX deactivation mode and associated with the cell DTX deactivation mode.

For example, the association between the configuration and cell DTX mode may be configured by the network device 120.

In some embodiments, the terminal device 110 switches from the first configuration to the second configuration for the DL signaling reception if the terminal device 110 enters the cell DTX mode of the serving cell for the DL signaling reception.

In some embodiments, the terminal device 110 switches from the second configuration to the first configuration for the downlink signaling reception if the terminal device 110 exits the cell DTX mode of the serving cell for the downlink signaling reception.

In some embodiments, the first configuration may comprise a first cell DRX configuration for a serving cell of the terminal device 110. The second configuration comprises an indication. The indication indicates to use at least one of the first plurality of resources during at least one of a first non-active duration and a first active duration of a first cell DRX pattern. The first cell DRX pattern is associated with the first cell DRX configuration.

In some embodiments, the terminal device 110 may determine the first active duration and the first non-active duration of the first cell DRX pattern based on the first cell DRX configuration. In turn, the terminal device 110 may determine, based on the indication, at least one of the first plurality of resources for the uplink signaling transmission during at least one of the first active duration and the first non-active duration.

In some embodiments, the indication indicates that the terminal device 110 does not use the first plurality of resources during the first non-active duration of the first cell DRX pattern. In other words, the indication indicates that the terminal device 110 only uses at least one the first plurality of resources for the uplink signaling transmission during the first active duration of the first cell DRX pattern. In such embodiments, the terminal device 110 determines or selects, based on the indication, none of the first plurality of resources for the uplink signaling transmission during the first non-active duration. In other words, the terminal device 110 determines or selects, based on the indication, the at least one of the first plurality of resources for the uplink signaling transmission only during the first active duration. In such embodiments, the first plurality of resources may comprise contention-free PRACH occasions and/or contention-based PRACH occasions.

In some embodiments, the indication indicates that the terminal device 110 does not use the first plurality of resources during the first non-active duration of the first cell DRX pattern. In other words, the indication indicates that the terminal device 110 only uses at least one of the first plurality of resources for the uplink signaling transmission during the first active duration of the first cell DRX pattern. In such embodiments, the terminal device 110 delays the initiation of the RA procedure till the first active duration of the first cell DRX pattern if the RA procedure is triggered during the first non-active duration.

Alternatively, in some embodiments, the at least one of the first plurality of resources comprises at least one contention-based PRACH occasion. The indication indicates that the terminal device 110 uses the at least one contention-based PRACH occasion during the first non-active duration of the first cell DRX pattern. In such embodiments, the terminal device 110 determines, based on the indication, the contention-based PRACH occasion for the uplink signaling transmission during the first non-active duration of the first cell DRX pattern.

Alternatively, in some embodiments, the at least one of the first plurality of resources overlaps with at least one resource indicated in System Information Block (SIB). The indication indicates that the terminal device 110 does not use at least one of the first plurality of resources during the first non-active duration only if the at least one of the first plurality of resources is not overlapped with at least one resource indicated in SIB. In other words, the indication indicates that the terminal device 110 only uses at least one resource indicated in SIB for the uplink signaling transmission during the first non-active duration of the first cell DRX pattern.

In such embodiments, the terminal device 110 determines whether at least one of the first plurality of resources overlaps with at least one resource indicated in SIB. If the at least one of the first plurality of resources overlaps with at least one resource indicated in SIB, the terminal device 110 determines, based on the indication, the at least one of the first plurality of resources for the uplink signaling transmission during the first non-active duration of the first cell DRX pattern. If one of the first plurality of resources does not overlap with a resource indicated in SIB, the terminal device 110 does not determine (or not select), based on the indication, the one of the first plurality of resources for the uplink signaling transmission during the first non-active duration of the first cell DRX pattern.

In some embodiments, the network device 120 may transmit the indication via RRC message, System Information Block, L1 signaling (such as Downlink Control Information) or L2 signaling (such as MAC CE).

In some embodiments, the network device 120 may transmit a cell DRX activation/deactivation command to the terminal device 110. The cell DRX activation/deactivation command may comprise a dedicated filed comprising the indication. The dedicated filed may be different from a field which is used to indicate activation/deactivation status of cell DRX mode.

Alternatively, in some embodiments, the field which is used to indicate activation/deactivation status of cell DRX mode may comprise the indication. In such embodiments, the network device 120 transmits the cell DRX activation/deactivation command for a serving cell to the terminal device 110. The cell DRX activation/deactivation command is used to indicate whether to activate/deactivate a cell DRX mode for the serving cell. Accordingly, the terminal device 110 receives the cell DRX activation/deactivation command.

In turn, the terminal device 110 selects the RACH type and/or at least one of the first plurality of RACH resources based on the cell DRX activation/deactivation command when initiating an RA procedure. If the cell DRX activation/deactivation command indicates to activate the cell DRX mode and the RA procedure is triggered during the first non-active duration of the first cell DRX pattern, when the terminal device 110 initiates the RA procedure by performing the actions as described above.

FIG. 9 illustrates a flowchart of a method 900 implemented at a terminal device in accordance with some embodiments of the present disclosure. For the purpose of discussion, the method 900 will be described from the perspective of the terminal device 110 with reference to FIG. 1.

At block 910, the terminal device 110 receives, from the network device 120, a first configuration for at least one of uplink transmission and downlink reception.

At block 920, the terminal device 110 receives, from the network device 120, a second configuration for at least one of an uplink signaling transmission and a downlink signaling reception.

At block 930, the terminal device 110 performs the uplink signaling transmission or the downlink signaling reception based on at least one of the first configuration and the second configuration.

In some embodiments, the first configuration indicates a first plurality of resources associated with a first periodicity; the second configuration indicates a second plurality of resources associated with a second periodicity; and the first periodicity is different from the second periodicity.

In some embodiments, the first configuration indicates a first plurality of resources associated with a first number of the first plurality of resources in a first periodicity; the second configuration indicates a second plurality of resources associated with a second number of the second plurality of resources in a second periodicity; and the first number is different from the second number.

In some embodiments, the first configuration indicates a first plurality of resources associated with a first value of Frequency-division multiplexing; the second configuration indicates a first plurality of resources associated with a second value of Frequency-division multiplexing; and the first value is different from the second value.

In some embodiments, the first configuration comprises a first cell Discontinuous Reception (DRX) configuration or a first cell Discontinuous Transmission (DTX) configuration for a serving cell of the terminal device, and the second configuration comprises a second cell DRX configuration or a second cell DTX configuration for the serving cell.

In some embodiments, performing the uplink signaling transmission comprises: determining a first non-active duration of a first cell DRX pattern based on the first cell DRX configuration; determining a second active duration of a second cell DRX pattern based on the second cell DRX configuration only during the first non-active duration of the first cell DRX pattern; and performing the uplink signaling transmission on at least one of the second plurality of resources during the second active duration.

In some embodiments, performing the downlink signaling reception comprises: determining a first non-active duration of a first cell DTX pattern based on the first cell DTX configuration; determining a second active duration of a second cell DTX pattern based on the second cell DTX configuration only during the first non-active duration of the first cell DTX pattern; and performing the downlink signaling reception on at least one of the second plurality of resources during the second active duration.

In some embodiments, performing the uplink signaling transmission comprises: determining a second non-active duration of the second cell DRX pattern based on the second cell DRX configuration; and determining none of the second plurality of resources for the uplink signaling transmission during the second non-active duration.

In some embodiments, performing the downlink signaling reception comprises: determining a second non-active duration of the second cell DTX pattern based on the second cell DTX configuration; and determining none of the second plurality of time resources for the down signaling reception during the second non-active duration.

In some embodiments, the first configuration comprises first information which indicates one of the following: a first index of Physical Random Access Channel (PRACH) configuration, a first value of PRACH Frequency-division multiplexing (FDM) configuration; a first PRACH periodicity of PRACH configuration, or a first number of PRACH occasions of PRACH configuration; and the second configuration comprises second information which indicates one of the following: a second index of PRACH configuration, a second value of PRACH FDM configuration; a second PRACH periodicity of PRACH configuration, or a second number of PRACH occasions of PRACH configuration.

In some embodiments, the second plurality of resources is a subset of the first plurality of resources.

In some embodiments, the terminal device is caused to perform the uplink signaling transmission or the downlink signaling reception by: performing the uplink signaling transmission or the downlink signaling reception on at least one of the second plurality of resources based on the second configuration.

In some embodiments, the method 900 further comprises: transmitting a request to the network device; and receiving the second configuration comprises: receiving a response to the request from the network device, the response comprising the second configuration.

In some embodiments, the first configuration comprises a first cell Discontinuous Reception (DRX) configuration for a serving cell of the terminal device; and the second configuration comprises an indication, the indication indicating to use at least one of the first plurality of resources during at least one of a first non-active duration and a first active duration of a first cell DRX pattern.

In some embodiments, performing the uplink signaling transmission comprises: determining the first active duration and the first non-active duration of the first cell DRX pattern based on the first cell DRX configuration; and determining, based on the indication, the at least one of the first plurality of resources for the uplink signaling transmission during the first active duration and/or the first non-active duration.

In some embodiments, the uplink signaling transmission comprises a transmission of a Random Access (RA) request.

In some embodiments, the method 900 further comprises: determining, based on the indication, the at least one of the first plurality of resources for the uplink signaling transmission during the first non-active duration. The at least one of the first plurality of resources comprise at least one of a contention-based physical random channel (PRACH) occasion and a contention-free PRACH occasion, or the at least one of the first plurality of resources overlapping with at least one resource indicated in System Information Block.

In some embodiments, the method 900 further comprises: determining or selects, based on the indication, the at least one of the first plurality of resources for the uplink signaling transmission only during the first active duration; or determining or selects, based on the indication, none of the first plurality of resources for the uplink signaling transmission during the first non-active duration.

In some embodiments, the uplink signaling transmission comprises a transmission of at least one of the following: Random Access request, Channel Status Information, Hybrid Automatic Repeat request feedback, Scheduling Request, Sounding Reference Signal, or Positioning Reference Signal.

In some embodiments, the down signaling reception comprises a reception of at least one of the following: Channel Status Information Reference Signal; or Positioning Reference Signal.

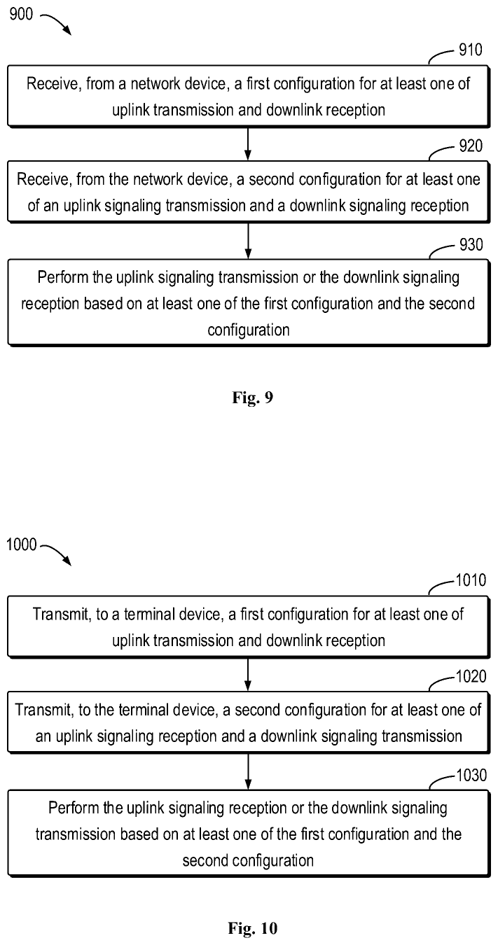

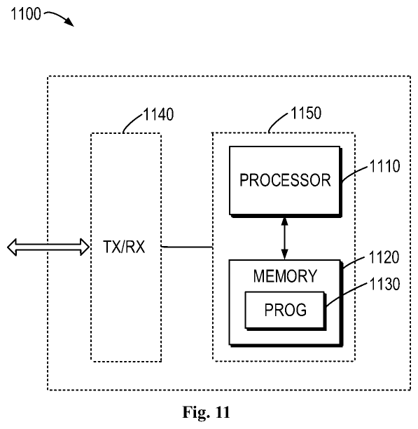

FIG. 10 illustrates a flowchart of a method 1000 implemented at a network device in accordance with some embodiments of the present disclosure. For the purpose of discussion, the method 1000 will be described from the perspective of the network device 120 with reference to FIG. 1.

At block 1010, the network device 120 transmits, to the terminal device 110, a first configuration for at least one of uplink transmission and downlink reception.

At block 1020, the network device 120 transmits, to the terminal device 110, a second configuration for at least one of an uplink signaling reception and a downlink signaling transmission.

At block 1030, the network device 120 performs the uplink signaling reception or the downlink signaling transmission based on at least one of the first configuration and the second configuration.

In some embodiments, the first configuration indicates a first plurality of resources associated with a first periodicity; the second configuration indicates a second plurality of resources associated with a second periodicity; and the first periodicity is different from the second periodicity.

In some embodiments, the first configuration indicates a first plurality of resources associated with a first number of the first plurality of resources in a first periodicity; the second configuration indicates a second plurality of resources associated with a second number of the second plurality of resources in a second periodicity; and the first number is different from the second number.

In some embodiments, the first configuration indicates a first plurality of resources associated with a first value of Frequency-division multiplexing; the second configuration indicates a first plurality of resources associated with a second value of Frequency-division multiplexing; and the first value is different from the second value.

In some embodiments, the first configuration comprises a first cell Discontinuous Reception (DRX) configuration or a first cell Discontinuous Transmission (DTX) configuration for a serving cell of the terminal device, and the second configuration comprises a second cell DRX configuration or a second cell DTX configuration for the serving cell.

In some embodiments, performing the uplink signaling reception comprises: determining a first non-active duration of a first cell DRX pattern based on the first cell DRX configuration; determining a second active duration of a second cell DRX pattern based on the second cell DRX configuration only during the first non-active duration of the first cell DRX pattern; and performing the uplink signaling reception on at least one of the second plurality of resources during the second active duration.

In some embodiments, performing the downlink signaling transmission comprises: determining a first non-active duration of a first cell DTX pattern based on the first cell DTX configuration; determining a second active duration of a second cell DTX pattern based on the second cell DTX configuration only during the first non-active duration of the first cell DTX pattern; and performing the downlink signaling transmission on at least one of the second plurality of resources during the second active duration.

In some embodiments, performing the uplink signaling reception comprises: determining a second non-active duration of the second cell DRX pattern based on the second cell DRX configuration; and determining none of the second plurality of resources for the uplink signaling reception during the second non-active duration.

In some embodiments, performing the downlink signaling transmission comprises: determining a second non-active duration of the second cell DTX pattern based on the second cell DTX configuration; and determining none of the second plurality of time resources for the down signaling reception during the second non-active duration.

In some embodiments, the first configuration comprises first information which indicates one of the following: a first index of Physical Random Access Channel (PRACH) configuration, a first value of PRACH Frequency-division multiplexing (FDM) configuration; a first PRACH periodicity of PRACH configuration, or a first number of PRACH occasions of PRACH configuration; and the second configuration comprises second information which indicates one of the following: a second index of PRACH configuration, a second value of PRACH FDM configuration; a second PRACH periodicity of PRACH configuration, or a second number of PRACH occasions of PRACH configuration.

In some embodiments, the second plurality of resources is a subset of the first plurality of resources.

In some embodiments, performing the uplink signaling reception or the downlink signaling transmission comprises: performing the uplink signaling reception or the downlink signaling transmission on at least one of the second plurality of resources based on the second configuration.

In some embodiments, the method 1000 further comprises: receiving a request from the terminal device; and transmitting the second configuration comprises: transmitting a response to the request via the transceiver to the terminal device, the response comprising the second configuration.

In some embodiments, the first configuration comprises a first cell Discontinuous Reception (DRX) configuration for a serving cell of the terminal device; and the second configuration comprises an indication, the indication indicating to use at least one of the first plurality of resources during at least one of a first non-active duration and a first active duration of a first cell DRX pattern.

In some embodiments, the indication indicates that the terminal device only uses at least one the first plurality of resources for the uplink signaling transmission during the first active duration of the first cell DRX pattern.

In some embodiments, the uplink signaling reception comprises a reception of a Random Access (RA) request.

In some embodiments, the at least one of the first plurality of resources comprises at least one contention-based physical random access channel (PRACH) occasion; and the indication indicates that the terminal device uses the at least one contention-based PRACH occasion during the first non-active duration of the first cell DRX pattern.

In some embodiments, the at least one of the first plurality of resources overlaps with at least one resource indicated in System Information Block (SIB); and the indication indicates that the terminal device only uses the at least one resource indicated in SIB for the uplink signaling transmission during the first non-active duration of the first cell DRX pattern.

In some embodiments, the uplink signaling reception comprises a reception of at least one of the following: Random Access request, Channel Status Information, Hybrid Automatic Repeat request feedback, Scheduling Request, Sounding Reference Signal, or Positioning Reference Signal.

In some embodiments, the down signaling transmission comprises a transmission of at least one of the following: Channel Status Information Reference Signal; or Positioning Reference Signal.

It shall be understood that the embodiments of the present disclosure which have been described with reference to FIGS. 1 to 8B are also applied to the methods 900 and 1000.

FIG. 11 illustrates a simplified block diagram of an apparatus 1100 that is suitable for implementing embodiments of the present disclosure. The apparatus 1100 can be considered as a further example implementation of the terminal device 110 or the network device 120 as shown in FIG. 1. Accordingly, the apparatus 1100 can be implemented at or as at least a part of the terminal device 110 or the network device 120.

As shown, the apparatus 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the apparatus 1100 to operate in accordance with the embodiments of the present disclosure, as discussed herein with reference to FIGS. 1 to 10. The embodiments herein may be implemented by computer software executable by the processor 1110 of the apparatus 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the apparatus 1100, there may be several physically distinct memory modules in the apparatus 1100. The processor 1110 may be of any type suitable to the local technical network, and may include one or more of general purpose computers, special purpose computers, microprocessors, digital signal processors (DSPs) and processors based on multicore processor architecture, as non-limiting examples. The apparatus 1100 may have multiple processors, such as an application specific integrated circuit chip that is slaved in time to a clock which synchronizes the main processor.

In summary, embodiments of the present disclosure provide the following solutions.
Clause 1. A terminal device, comprising: a processor; and a transceiver coupled to the processor, wherein the processor is configured to: receive, via the transceiver from a network device, a first configuration for at least one of uplink transmission and downlink reception; receive, via the transceiver from the network device, a second configuration for at least one of an uplink signaling transmission and a downlink signaling reception; and perform the uplink signaling transmission or the downlink signaling reception based on at least one of the first configuration and the second configuration.
Clause 2. The terminal device of clause 1, wherein the first configuration indicates a first plurality of resources associated with a first periodicity; the second configuration indicates a second plurality of resources associated with a second periodicity; and the first periodicity is different from the second periodicity.
Clause 3. The terminal device of clause 1, wherein the first configuration indicates a first plurality of resources associated with a first number of the first plurality of resources in a first periodicity; the second configuration indicates a second plurality of resources associated with a second number of the second plurality of resources in a second periodicity; and the first number is different from the second number.
Clause 4. The terminal device of clause 1, wherein the first configuration indicates a first plurality of resources associated with a first value of Frequency-division multiplexing; the second configuration indicates a first plurality of resources associated with a second value of Frequency-division multiplexing; and the first value is different from the second value.
Clause 5. The terminal device of any of clauses 2 to 4, wherein the first configuration comprises a first cell Discontinuous Reception (DRX) configuration or a first cell Discontinuous Transmission (DTX) configuration for a serving cell of the terminal device, and the second configuration comprises a second cell DRX configuration or a second cell DTX configuration for the serving cell.
Clause 6. The terminal device of clause 5, wherein the terminal device is caused to perform the uplink signaling transmission by: determining a first non-active duration of a first cell DRX pattern based on the first cell DRX configuration; determining a second active duration of a second cell DRX pattern based on the second cell DRX configuration only during the first non-active duration of the first cell DRX pattern; and performing the uplink signaling transmission on at least one of the second plurality of resources during the second active duration.
Clause 7. The terminal device of clause 5, wherein the terminal device is caused to perform the downlink signaling reception by: determining a first non-active duration of a first cell DTX pattern based on the first cell DTX configuration; determining a second active duration of a second cell DTX pattern based on the second cell DTX configuration only during the first non-active duration of the first cell DTX pattern; and performing the downlink signaling reception on at least one of the second plurality of resources during the second active duration.
Clause 8. The terminal device of clause 5, wherein the terminal device is caused to perform the uplink signaling transmission by: determining a second non-active duration of the second cell DRX pattern based on the second cell DRX configuration; and determining none of the second plurality of resources for the uplink signaling transmission during the second non-active duration.
Clause 9. The terminal device of clause 5, wherein the terminal device is caused to perform the downlink signaling reception by: determining a second non-active duration of the second cell DTX pattern based on the second cell DTX configuration; and determining none of the second plurality of time resources for the down signaling reception during the second non-active duration.
Clause 10. The terminal device of any of clauses 2 to 4, wherein the first configuration comprises first information which indicates one of the following: a first index of Physical Random Access Channel (PRACH) configuration, a first value of PRACH Frequency-division multiplexing (FDM) configuration; a first PRACH periodicity of PRACH configuration, or a first number of PRACH occasions of PRACH configuration; and the second configuration comprises second information which indicates one of the following: a second index of PRACH configuration, a second value of PRACH FDM configuration; a second PRACH periodicity of PRACH configuration, or a second number of PRACH occasions of PRACH configuration.
Clause 11. The terminal device of clause 3, wherein the second plurality of resources is a subset of the first plurality of resources.
Clause 12. The terminal device of clause 10 or 11, wherein the terminal device is caused to perform the uplink signaling transmission or the downlink signaling reception by: performing the uplink signaling transmission or the downlink signaling reception on at least one of the second plurality of resources based on the second configuration.
Clause 13. The terminal device of clause 1, wherein the terminal device is further caused to transmit a request via the transceiver to the network device; and the terminal device is caused to receive the second configuration by receiving a response to the request via the transceiver from the network device, the response comprising the second configuration.
Clause 14. The terminal device of any of clauses 2 to 4, wherein the first configuration comprises a first cell Discontinuous Reception (DRX) configuration for a serving cell of the terminal device; and the second configuration comprises an indication, the indication indicating to use at least one of the first plurality of resources during at least one of a first non-active duration and a first active duration of a first cell DRX pattern.
Clause 15. The terminal device of clause 14, wherein the terminal device is caused to perform the uplink signaling transmission by: determining the first active duration and the first non-active duration of the first cell DRX pattern based on the first cell DRX configuration; and determining, based on the indication, the at least one of the first plurality of resources for the uplink signaling transmission during the first active duration and/or the first non-active duration.
Clause 16. The terminal device of clause 15, wherein the uplink signaling transmission comprises a transmission of a Random Access (RA) request.
Clause 17. The terminal device of clause 16, wherein the terminal device is caused to determine, based on the indication, the at least one of the first plurality of resources for the uplink signaling transmission during the first non-active duration; and the at least one of the first plurality of resources comprise at least one of a contention-based physical random channel (PRACH) occasion and a contention-free PRACH occasion, or the at least one of the first plurality of resources overlapping with at least one resource indicated in System Information Block.
Clause 18. The terminal device of clause 16, wherein the terminal device is caused to determine, based on the indication, the at least one of the first plurality of resources for the uplink signaling transmission only during the first active duration; or the terminal device is caused to determine, based on the indication, none of the first plurality of resources for the uplink signaling transmission during the first non-active duration.
Clause 19. The terminal device of clause 1, wherein the uplink signaling transmission comprises a transmission of at least one of the following: Random Access request, Channel Status Information, Hybrid Automatic Repeat request feedback, Scheduling Request, Sounding Reference Signal, or Positioning Reference Signal.
Clause 20. The terminal device of clause 1, wherein the down signaling reception comprises a reception of at least one of the following: Channel Status Information Reference Signal; or Positioning Reference Signal.
Clause 21. A network device, comprising: a processor; and a transceiver coupled to the processor, wherein the processor is configured to: transmit, via the transceiver to a terminal device, a first configuration for at least one of uplink transmission and downlink reception; transmit, via the transceiver to the terminal device, a second configuration for at least one of an uplink signaling reception and a downlink signaling transmission; and perform the uplink signaling reception or the downlink signaling transmission based on at least one of the first configuration and the second configuration.
Clause 22. The network device of clause 21, wherein the first configuration indicates a first plurality of resources associated with a first periodicity; the second configuration indicates a second plurality of resources associated with a second periodicity; and the first periodicity is different from the second periodicity.
Clause 23. The network device of clause 21, wherein the first configuration indicates a first plurality of resources associated with a first number of the first plurality of resources in a first periodicity; the second configuration indicates a second plurality of resources associated with a second number of the second plurality of resources in a second periodicity; and the first number is different from the second number.
Clause 24. The network device of clause 21, wherein the first configuration indicates a first plurality of resources associated with a first value of Frequency-division multiplexing;
the second configuration indicates a first plurality of resources associated with a second value of Frequency-division multiplexing; and the first value is different from the second value.
Clause 25. The network device of any of clauses 22 to 24, wherein the first configuration comprises a first cell Discontinuous Reception (DRX) configuration or a first cell Discontinuous Transmission (DTX) configuration for a serving cell of the terminal device, and the second configuration comprises a second cell DRX configuration or a second cell DTX configuration for the serving cell.
Clause 26. The network device of clause 25, wherein the network device is caused to perform the uplink signaling reception by: determining a first non-active duration of a first cell DRX pattern based on the first cell DRX configuration; determining a second active duration of a second cell DRX pattern based on the second cell DRX configuration only during the first non-active duration of the first cell DRX pattern; and performing the uplink signaling reception on at least one of the second plurality of resources during the second active duration.
Clause 27. The network device of clause 25, wherein the network device is caused to perform the downlink signaling transmission by: determining a first non-active duration of a first cell DTX pattern based on the first cell DTX configuration; determining a second active duration of a second cell DTX pattern based on the second cell DTX configuration only during the first non-active duration of the first cell DTX pattern; and performing the downlink signaling transmission on at least one of the second plurality of resources during the second active duration.
Clause 28. The network device of clause 25, wherein the network device is caused to perform the uplink signaling reception by: determining a second non-active duration of the second cell DRX pattern based on the second cell DRX configuration; and determining none of the second plurality of resources for the uplink signaling reception during the second non-active duration.
Clause 29. The network device of clause 25, wherein the network device is caused to perform the downlink signaling transmission by: determining a second non-active duration of the second cell DTX pattern based on the second cell DTX configuration; and determining none of the second plurality of time resources for the down signaling reception during the second non-active duration.
Clause 30. The network device of any of clauses 22 to 24, wherein the first configuration comprises first information which indicates one of the following: a first index of Physical Random Access Channel (PRACH) configuration, a first value of PRACH Frequency-division multiplexing (FDM) configuration; a first PRACH periodicity of PRACH configuration, or a first number of PRACH occasions of PRACH configuration; and the second configuration comprises second information which indicates one of the following: a second index of PRACH configuration, a second value of PRACH FDM configuration; a second PRACH periodicity of PRACH configuration, or a second number of PRACH occasions of PRACH configuration.
Clause 31. The network device of clause 23, wherein the second plurality of resources is a subset of the first plurality of resources.
Clause 32. The network device of clause 30 or 31, wherein the network device is caused to perform the uplink signaling reception or the downlink signaling transmission by:
performing the uplink signaling reception or the downlink signaling transmission on at least one of the second plurality of resources based on the second configuration.
Clause 33. The network device of clause 21, wherein the network device is further caused to: receive a request via the transceiver from the terminal device; and the network device is caused to transmit the second configuration by transmitting a response to the request via the transceiver to the terminal device, the response comprising the second configuration.
Clause 34. The network device of any of clauses 22 to 24, wherein the first configuration comprises a first cell Discontinuous Reception (DRX) configuration for a serving cell of the terminal device; and the second configuration comprises an indication, the indication indicating to use at least one of the first plurality of resources during at least one of a first non-active duration and a first active duration of a first cell DRX pattern.
Clause 35. The network device of clause 34, wherein the indication indicates that the terminal device only uses at least one the first plurality of resources for the uplink signaling transmission during the first active duration of the first cell DRX pattern.
Clause 36. The network device of clause 35, wherein the uplink signaling reception comprises a reception of a Random Access (RA) request.
Clause 37. The network device of clause 36, wherein the at least one of the first plurality of resources comprises at least one contention-based physical random access channel (PRACH) occasion; and the indication indicates that the terminal device uses the at least one contention-based PRACH occasion during the first non-active duration of the first cell DRX pattern.
Clause 38. The network device of clause 36, wherein the at least one of the first plurality of resources overlaps with at least one resource indicated in System Information Block (SIB); and the indication indicates that the terminal device only uses the at least one resource indicated in SIB for the uplink signaling transmission during the first non-active duration of the first cell DRX pattern.
Clause 39. The network device of clause 21, wherein the uplink signaling reception comprises a reception of at least one of the following: Random Access request, Channel Status Information, Hybrid Automatic Repeat request feedback, Scheduling Request, Sounding Reference Signal, or Positioning Reference Signal.
Clause 40. The network device of clause 21, wherein the down signaling transmission comprises a transmission of at least one of the following: Channel Status Information Reference Signal; or Positioning Reference Signal.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE), comprising:
at least one memory; and
at least one processor coupled with the at least one memory and configured to cause the UE to:
receive a first configuration for at least one of uplink transmission or downlink reception;
receive a second configuration for at least one of an uplink signaling transmission or a downlink signaling reception in a layer 3 message; and
perform the uplink signaling transmission or the downlink signaling reception based on at least one of the first configuration or the second configuration.

2. The UE of claim 1, wherein:
the first configuration indicates a first plurality of resources associated with a first number of the first plurality of resources in a first periodicity;
the second configuration indicates a second plurality of resources associated with a second number of the second plurality of resources in a second periodicity; and
each of the first plurality of resources and the second plurality of resources comprise at least one of a time resource or a frequency resource.

3-8. (canceled)

9. The UE of claim 1, wherein the uplink signaling transmission comprises a transmission of a Random Access request.

10. (canceled)

11. A network equipment (NE), comprising:
at least one memory; and
at least one processor coupled with the at least one memory and configured to cause the NE to:
transmit a first configuration for at least one of uplink transmission or downlink reception;
transmit a second configuration for at least one of an uplink signaling reception or a downlink signaling transmission in a layer 3 message; and
perform the uplink signaling reception or the downlink signaling transmission based on at least one of the first configuration or the second configuration.

12. The NE of claim 11, wherein:
the first configuration indicates a first plurality of resources associated with a first number of the first plurality of resources in a first periodicity;
the second configuration indicates a second plurality of resources associated with a second number of the second plurality of resources in a second periodicity; and
the first number is different from the second number.

13-15. (canceled)

16. The UE of claim 1, wherein the first configuration comprises information indicating at least one of the following:
a first index of a physical random access channel (PRACH) configuration;
a first PRACH periodicity of the PRACH configuration;
a first number of PRACH occasions of the PRACH configuration; or
a first value of a PRACH frequency-division multiplexing (FDM) configuration,
wherein the first index is associated with the first number of PRACH occasions of the PRACH configuration, and
wherein the first value of the PRACH FDM configuration comprises a first msg1-Frequency Start or a first msg1-FDM.

17. The UE of claim 1, wherein the second configuration comprises information indicating at least one of the following:
a second index of a physical random access channel (PRACH) configuration;
a second PRACH periodicity of the PRACH configuration;
a second number of PRACH occasions of the PRACH configuration; or
a second value of a PRACH frequency-division multiplexing (FDM) configuration,
wherein the second PRACH configuration index is associated with the second number of PRACH occasions of the PRACH configuration, and
wherein the second value of the PRACH FDM configuration comprises a second msg1-FrequencyStart or a second msg1-FDM.

18. The UE of claim 1, wherein the at least one processor is configured to cause the UE to perform the uplink signaling transmission on at least one of a second plurality of physical random access channel (PRACH) occasions after receiving a command in a layer 1 signaling by a physical downlink control channel (PDCCH).

19. The UE of claim 18, wherein the PDCCH is scrambled with a predefined specific group or common Radio Network Temporary Identifier (RNTI).

20. The UE of claim 18, wherein, in response to the command not indicating which cell(s) to apply the command, the at least one processor is configured to cause the UE to apply the command to a serving cell from which the command is received.

21. The UE of claim 18, wherein the at least one processor is configured to cause the UE to apply the command immediately upon receiving the command or at a current RACH period.

22. A method performed by a user equipment (UE), comprising:
receiving a first configuration for at least one of uplink transmission or downlink reception;
receiving a second configuration for at least one of an uplink signaling transmission or a downlink signaling reception in a layer 3 message; and
performing the uplink signaling transmission or the downlink signaling reception based on at least one of the first configuration or the second configuration.

23. The method of claim 22, wherein:
the first configuration indicates a first plurality of resources associated with a first number of the first plurality of resources in a first periodicity;
the second configuration indicates a second plurality of resources associated with a second number of the second plurality of resources in a second periodicity; and
each of the first plurality of resources and the second plurality of resources comprise at least one of a time resource or a frequency resource.

24. The method of claim 22, wherein the first configuration comprises information indicating at least one of the following:
a first index of a physical random access channel (PRACH) configuration;
a first PRACH periodicity of the PRACH configuration;
a first number of PRACH occasions of the PRACH configuration; or
a first value of a PRACH frequency-division multiplexing (FDM) configuration,
wherein the first index is associated with the first number of PRACH occasions of the PRACH configuration, and
wherein the first value of the PRACH FDM configuration comprises a first msg1-Frequency Start or a first msg1-FDM.

25. The method of claim 22, wherein the second configuration comprises information indicating at least one of the following:
a second index of a physical random access channel (PRACH) configuration;
a second PRACH periodicity of the PRACH configuration;
a second number of PRACH occasions of the PRACH configuration; or
a second value of a PRACH frequency-division multiplexing (FDM) configuration,
wherein the second PRACH configuration index is associated with the second number of PRACH occasions of the PRACH configuration, and
wherein the second value of the PRACH FDM configuration comprises a second msg1-FrequencyStart or a second msg1-FDM.

26. The method of claim 22, further comprising performing the uplink signaling transmission on at least one of a second plurality of physical random access channel (PRACH) occasions after receiving a command in a layer 1 signaling by a physical downlink control channel (PDCCH).

27. The method of claim 26, wherein the PDCCH is scrambled with a predefined specific group or common Radio Network Temporary Identifier (RNTI).

28. The method of claim 26, further comprising, in response to the command not indicating which cell(s) to apply the command, applying the command to a serving cell from which the command is received.

29. The method of claim 26, further comprising applying the command immediately upon receiving the command or at a current RACH period.

30. A method performed by a first network equipment (NE), comprising:
transmit a first configuration for at least one of uplink transmission or downlink reception;
transmit a second configuration for at least one of an uplink signaling reception or a downlink signaling transmission in a layer 3 message; and
perform the uplink signaling reception or the downlink signaling transmission based on at least one of the first configuration or the second configuration.
